(19) United States
(12) Patent Application Publication
(10) Pub. No.: US 2023/0044785 A1
(43) Pub. Date: Feb. 9, 2023

(54) DISPERSIBLE SPICE PELLETS

(71) Applicants: TATA CHEMICALS LIMITED, Mumbai (IN); TATA CONSUMER PRODUCTS LIMITED, Kolkata (IN)

(72) Inventors: Shashikala M. N, Pune (IN); Satyanarayana Reddy J, Pune (IN); Alina Mukharjee, Kolkata (IN)

(73) Assignees: TATA CHEMICALS LIMITED, Mumbai (IN); TATA CONSUMER PRODUCTS LIMITED, Kolkata (IN)

(21) Appl. No.: 17/786,471

(22) PCT Filed: Dec. 16, 2020
(86) PCT No.: PCT/IB2020/061999

§ 371 Date: Jun. 16, 2022

(30) Foreign Application Priority Data
Dec. 17, 2019 (IN) 201921052387

(51) Int. Cl. A23L 27/10; A23L 33/24; A23L 33/115; A23L 33/125

(52) U.S. Cl. CPC A23L 27/10; A23L 33/24; A23L 33/115; A23L 33/125

(57) ABSTRACT

The present disclosure relates to a spice pellet comprising oligosaccharide in the range of 3-40% w/w of the total weight of the spice pellet, hydroxy propyl methyl cellulose (HPMC) in the range of 1-15% w/w of the total weight of the spice pellet, clarified butter in the range of 5-10% w/w of the total weight of the spice pellet, spice mixture in the range of 50-90% w/w of the total weight of the spice pellet. The present disclosure also relates to a method of making the spice pellet.

### FIELD OF INVENTION

The present disclosure relates to a spice pellet and a process of preparing the same.

### BACKGROUND

Spice pellets or bouillon cubes are commonly used to provide flavourings to soups, gravies, sauces and similar foods. These cubes are typically composed of dehydrated vegetable or meat stock, fat, sugar, monosodium glutamate (MSG), salt and spices. These components are shaped to form a small cube, disc, or a pellet. During cooking of food such cubes or pellets are usually added to hot water or gravy along with vegetables and/or meat or to hot soup.

In the bouillon cubes that are currently available in the market, high amounts of fat and sugar are added. Fat is added to maintain the shape and hardness of the cube and to lower its friability. Sugar is added to aid in crystallization of fat and to enhance taste or flavour of the food. In addition, sugar also reduces the water activity in the cubes thereby helping to extend their shelf life. Bouillon cubes, that are available in the market may include as high as 50% sugar, making them unhealthy especially for the diabetic population. Since the amount of sugar, oils, and/or fat have to be added in larger amounts as compared to the spices to maintain the desired properties of the cubes this results in inadequate mouth feel. In order to achieve adequate mouthfeel, unhealthy taste enhancers are added. Moreover, in the cubes that are currently available, binders such as flour, starch is also added to keep the shape and hardness of the cubes. Up to 50% of the bouillon cubes may actually comprise of such binders, thus, further reducing the amount of spices in said cubes. Addition of fats, sugars, starch in large amounts makes the cube unhealthy for daily use.

### SUMMARY

The present disclosure relates to a spice pellet comprising oligosaccharide in the range of 3-40% w/w of the total weight of the spice pellet, hydroxy propyl methyl cellulose (HPMC) in the range of 1-15% w/w of the total weight of the spice pellet, clarified butter in the range of 5-10% w/w of the total weight of the spice pellet, spice mixture in the range of 50-90% w/w of the total weight of the spice pellet.

The present disclosure also relates to a method of making the spice pellet, the method comprising preparing a dry mixture comprising a spice mixture, oligosaccharide, and hydroxyl propyl methyl cellulose (HPMC); adding to the dry mixture healthy oil to obtain a spice pellet blend; cooling the spice pellet blend and shaping the cooled spice pellet blend into pellet or cube, wherein fructooligosaccharide (FOS) in the range of 3-40% w/w of the total weight of the spice pellet; hydroxy propyl methyl cellulose (HPMC) in the range of 1-15% w/w of the total weight of the spice pellet; healthy oil in the range 5-10% w/w of the total weight of the spice pellet; and spice mixture in the range of 50-90% w/w of the total weight of the spice pellet.

### DETAILED DESCRIPTION

For the purpose of promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment”, “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

The present disclosure relates to a spice pellet or a bouillon cube. The term “spice pellet” or “bouillon cubes” can be interchangeably used with each in the present disclosure and in the context of the present disclosure means all-purpose seasoning and condiment used to flavour vegetables, soups, curries, and stews. The “bouillon cubes” or “spice pellet” can be of any shape or size, or form. The form may include tablet, disc, or any known form to the person skilled in the art.

The present disclosure relates to a spice pellet comprising oligosaccharide, a spice mixture, hydroxy propyl methyl cellulose (HPMC), and healthy oils. In accordance with an embodiment, the spice pellet may be devoid of fillers.

In accordance with an aspect, the spice pellet comprises of oligosaccharide in the range of 3-40% w/w of the total weight of the spice pellet, a spice mixture in the range of 50-90% w/w of the total weight of the spice pellet, hydroxy propyl methyl cellulose (HPMC) in the range of 1-15% w/w of the total weight of the spice pellet; and healthy oils in the range 5-10% w/w of the total weight of the spice pellet.

In accordance with an aspect, oligosaccharide comprises between 3 to 40% of total weight of the spice pellet. In accordance with an embodiment, the oligosaccharide (FOS) is present in the range of 5-20% w/w of the total weight of the spice pellet.

The oligosaccharide may be selected from the group consisting of fructooligosaccharide (FOS), Galactooligosaccharide (GOS), Xylooligosaccharide (XOS), Mannan Oligosaccharide (MOS), or a combination thereof.

In accordance with an aspect, oligosaccharide is fructooligosaccharide (FOS). In yet another embodiment, fructooligosaccharide is inulin.

Without being bound by any particular theory, fructooligosaccharide (FOS) in the spice pellet provides a high moisture-retaining capacity, prevents excessive drying, and provides low water activity, which results in controlling microbial contamination, and increase in shelf life. Fructooligosaccharide (FOS) also forms gels with fat crystals in the heathy oils, which results in achieving both taste and bulk at the same time, besides acting as texturizing agent. The higher molecular weight of fructooligosaccharide (FOS) provides increased viscosity, further contributing to the improved body and mouthfeel.

In accordance with an aspect, 50-90% w/w of the total weight of the spice pellet comprises of a mixture of spices. In accordance with an embodiment, the spice mixture may in the range of 70-90% w/w of the total weight of the spice pellet.

In accordance with an embodiment, the spice mixture may comprise of spices selected from a group comprising garlic powder, onion powder, white pepper powder, coriander powder, cumin powder, ginger powder, turmeric, fennel powder, red chili flakes, cardamom, nutmeg, chicken extract powder, or combinations thereof. The spice mixture further comprises salt. The spice mixture according to an embodiment comprises of at least one spice selected from the disclosed group along with salt. The composition of the spice mixture depends of the use of the spice pellet. For example, a vegetarian version of the spice pellet will include only a mixture of spices such as garlic powder, onion powder, white pepper powder, coriander powder, cumin powder, ginger powder, turmeric, fennel powder, red chilli flakes, cardamom, nutmeg along with salt but will not include chicken, mutton or fish extract. By way of another example if the spice pellet is to be used for flavouring a chicken dish, the spice pellet will include chicken extract along with other spices and salt. Similarly, if the spice pellet is used for flavouring a meat or fish dish, the spice pellet will include meat of fish extract along with other spices and salt. Spice mixture may also be varied depending upon the how spicy or hot the flavour is required.

The spice mixture may further comprise of flavoring agent selected from a group comprising disodium inosinate and disodium guanylate (I+G), citric acid, or combinations thereof.

By way of a specific example, the spice mixture has the following composition: garlic powder in the amount of 16.5 wt. % of the total composition of the spice mixture, onion powder in the amount of 16.5 wt. % of the total composition of the spice mixture, white pepper powder in the amount of 6.2 wt. % of the total composition of the spice mixture, coriander powder in the amount of 8.9 wt. % of the total composition of the spice mixture, cumin powder in the amount of 7.6 wt. % of the total composition of the spice mixture, nutmeg in the amount of 6.4 wt. % of the total composition of the spice mixture, ginger powder in the amount of 4.9 wt. % of the total composition of the spice mixture, turmeric in the amount of 2.7 wt. % of the total composition of the spice mixture, fennel powder in the amount of 4 wt. % of the total composition of the spice mixture, red chillies in the amount of 8.1 wt. % of the total composition of the spice mixture, salt in the amount of 14 wt. % of the total composition of the spice mixture, I+G in the amount of 3 wt. % of the total composition of the spice mixture, and citric acid in the amount of 0.96 wt. % of the total composition of the spice mixture.

In addition to the FOS and the spice mixture, the spice pellet also comprises 1-15% w/w of hydroxy propyl methyl cellulose (HPMC) of the total weight of the spice pellet. The hydroxy propyl methyl cellulose acts as a bulking agent and helps the spice pellet in retaining its form. In accordance with an embodiment, the amount of Hydroxy propyl methyl cellulose (HPMC) in the spice pellet may be less than 2 wt. % of the total composition.

The spice pellet further comprises healthy oils in the range of 5-10% w/w of the total weight of the spice pellet. In accordance with an embodiment, the amount of healthy oil may less than 5 wt. % of the total composition.

Healthy oil as herein disclosed is an oil or fat selected from the group comprising of clarified butter, olive oil, coconut oil etc.

In accordance with an embodiment, healthy oil is clarified butter. Clarified butter as herein disclosed is milk fat obtained by heating butter at high temperatures. The clarified butter may be obtained from cow milk, buffalo milk or their mixture. However, clarified butter may also be obtained from other milk such as sheep milk, goat milk, yak milk or camel milk. Clarified butter is a healthy fat and is a good source of fat-soluble vitamins (A, D, E and K) and essential fatty acids. Clarified butter also contributes in providing a rich taste to the spice pellets.

In accordance with an embodiment, the spice pellet may also comprise of additional fortification agents. The fortification agent may comprise 0.5-5% w/w of total weight to the spice pellet. The fortification agent may be selected from the group comprising whey protein, iron, vitamin B, ascorbic acid, or a combination thereof. In accordance with an embodiment, the fortification agent is whey protein. In accordance with an alternate embodiment, the fortification agent is iron.

The spice pellet having the composition as disclosed above is such that it disperses in water at a temperature in the range of 70° C. to 90° C. in less than 60 seconds. Specifically, the spice pellet may disperse in water at a temperature in the range of 70° C. to 90° C. in less than 50 seconds. More specifically, the spice pellet may disperse in water at a temperature in the range of 70° C. to 90° C. in the time period of 40 seconds to 50 seconds.

The present disclosure also relates to a method of making the spice pellet. The method comprises of preparing a dry mixture comprising a spice mixture, FOS and HPMC. To the dry mixture healthy oil is added to obtain a spice pellet blend. The spice pellet blend is cooled and then shaped into pellets or cubes.

In accordance with an alternate embodiment, the process comprises of first forming a spice mixture. In the next step the spice mixture and FOS are mixed together, followed by addition of HPMC to form the dry mixture. To the dry mixture healthy oil is added to obtain a spice pellet blend. The spice pellet blend is cooled and then shaped into pellets or cubes.

Spice Blend

| Ingredients | Weight (g) |
|---|---|
| Garlic powder | 16.5 |
| Onion powder | 16.5 |
| White pepper powder | 6.2 |
| Coriander powder | 8.9 |
| Cumin powder | 7.6 |
| Nutmeg | 6.4 |
| Ginger powder | 4.9 |
| Turmeric | 2.7 |
| Fennel powder | 4.0 |
| Red chilli flakes | 8.1 |
| Salt | 14 |
| I + G | 3 |
| Citric acid | 0.96 |
| Total | 100 |

In accordance with an aspect, at least two spices are mixed to form the spice mixture. In accordance with an embodiment, the spices that may be added to the form the spice mixture are selected from the group comprising one or more of: garlic powder, onion powder, white pepper powder, coriander powder, cumin powder, ginger powder, turmeric, fennel powder, red chili flakes, cardamom, nutmeg, chicken extract powder, or combinations thereof. In accordance with an embodiment, salt is further added along with the spices to form the spice mixture. In accordance with an embodiment, disodium inosinate and disodium guanylate (I+G), citric acid, or combinations thereof is further added to the spices to form the spice mixture.

The spices and salt are mixed together in such a quantity to form 100% of spice mixture. In such an embodiment the first step in the method of making the spice pellet is forming the spice mixture by combining the spices together. The table below provides an example of the spices and their quantities that are mixture together to form the spice mixture.

In an alternate embodiment, the spices and if required salt may be directly added along with the FOS and the HPMC. In such an embodiment, the spices and salt are added such that the total spice and salt content is as required in the final spice pellet.

In accordance with an embodiment, fortifying agent selected from a group comprising whey protein, iron, vitamin B, ascorbic acid, or combination thereof, is added to the dry mixture. These fortifying agents may be added separately to the dry mixture or may be mixed with HPMC before being added to the dry mixture.

In accordance with an embodiment, where the healthy oil is clarified butter, it may add such that it is a molten state. The clarified butter for example may be heated prior to being added to the dry mixture. In accordance with an embodiment, clarified butter may be heated to a temperature in the range of 25° C. to 30° C., before it is added to the dry mixture.

Once healthy oil is added to the dry mixture, to obtain the spice pellet blend, the spice pellet blend is cooled to a temperature in the range of 5° C. to 20° C., for between 5 min to 1 hour. Specifically, the spice pellet blend may be cooled to a temperature of 15° C. for 10 minutes.

In accordance with an embodiment, in the method of making the spice pellet, the spice pellet blend is mixed after cooling and before being shaped into pellets or cubes. Mixing the spice pellet blend after cooling results in better homogeneity of all the components of the spice pellet and allows obtaining spice pellets that has substantially homogenous composition.

In the last step of the process the spice pellet blend is pressed into space such as cubes, tables etc., by any known method, including but not limited to hydraulic pellet press or any other known tablet making machine. In accordance with an embodiment the pellets are formed by using a hydraulic pellet press at 1-ton pressure.

In an aspect, the spice mixture is added in an amount of 50-90% w/w of the total weight of the spice pellet. Specifically, spice mixture is added in the amount of 70-90% of the total weight of the spice pellet.

The oligosaccharide is added in the range of 3% to 40% w/w of the total weight of the spice pellet. Specifically, the amount of oligosaccharide added in the range of 5% to 20% w/w of the total weight of the spice pellet.

The oligosaccharide may be selected from the group consisting of fructooligosaccharide (FOS), Galactooligosaccharide (GOS), Xylooligosaccharide (XOS), Mannan Oligosaccharide (MOS), or a combination thereof.

In accordance with an aspect, oligosaccharide is fructooligosaccharide (FOS). In yet another embodiment, fructooligosaccharide is inulin.

The Hydroxy propyl methyl cellulose (HPMC) is added in the range of 1 to 15% w/w of the total weight of the spice pellet. Specifically, the amount of Hydroxy propyl methyl cellulose (HPMC) added in the range of 1.5% to 7% w/w of the total weight of the spice pellet. In accordance with an embodiment, the amount of HPMC in the spice pellet may be less than 2 wt % of the total weight of the spice pellet.

The healthy oil such as clarified butter is added in the range of 0.5 to 10% w/w of the total weight of the spice pellet. Specifically, the amount of clarified butter added in the range of 1% to 5% w/w of the total weight of the spice pellet. In accordance with an embodiment, the amount of clarified butter and healthy oils may less than 5 wt. % of the total weight of the spice pellet.

### SPECIFIC EMBODIMENTS OF THE INVENTION

A spice pellet comprising: oligosaccharide in the range of 3-40% w/w of the total weight of the spice pellet; hydroxy propyl methyl cellulose (HPMC) in the range of 1-15% w/w of the total weight of the spice pellet; healthy oil in the range 5-10% w/w of the total weight of the spice pellet; and spice mixture in the range of 50-90% w/w of the total weight of the spice pellet.

Such spice pellet is disclosed, wherein the oligosaccharide is selected from the group consisting of: fructooligosaccharide, Galactooligosaccharide (GOS), Xylooligosaccharide (XOS), Mannan Oligosaccharide (MOS), or a combination thereof.

Such spice pellet is disclosed, wherein the oligosaccharide is fructooligosaccharide (FOS).

Such spice pellet is disclosed, wherein the spice mixture comprises of spices selected from a group comprising garlic powder, onion powder, white pepper powder, coriander powder, cumin powder, ginger powder, turmeric, fennel powder, red chilli flakes, cardamom, nutmeg, chicken extract powder, or combinations thereof.

Such spice pellet is disclosed, wherein the spice mixture further comprises flavoring agent selected from a group comprising disodium inosinate and disodium guanylate (I+G), citric acid, or combinations thereof.

Such spice pellet is disclosed, comprising fortifying agent selected form a group comprising of whey protein, iron, ascorbic acid, vitamin B or a combination thereof.

Such spice pellet is disclosed, wherein the FOS is in the range of 5-20% w/w of the total weight of the spice pellet.

Such spice pellet is disclosed, wherein the FOS is in the range of 5-20% w/w of the total weight of the spice pellet.

Such spice pellet is disclosed, wherein the spice mixture is in the range of 70-90% w/w of the total weight of the spice pellet.

Such spice pellet is disclosed, wherein the amount of HPMC is less than 2 wt. % of the total weight of the spice pellet.

Such spice pellet is disclosed, wherein the amount of clarified butter is less than 5 wt. % of the total weight of the spice pellet.

Such spice pellet is disclosed, wherein the spice pellet dissolves in hot water in less than 60 seconds at a temperature in the range of 70° C. to 90° C.

A method of making the spice pellet, the method comprising preparing a dry mixture comprising a spice mixture, oligosaccharide, and hydroxyl propyl methyl cellulose (HPMC); adding to the dry mixture healthy oil to obtain a spice pellet blend; cooling the spice pellet blend and shaping the cooled spice pellet blend into pellet or cube, wherein fructooligosaccharide (FOS) in the range of 3-40% w/w of the total weight of the spice pellet; hydroxy propyl methyl cellulose (HPMC) in the range of 1-15% w/w of the total weight of the spice pellet; healthy oil in the range 5-10% w/w of the total weight of the spice pellet; and spice mixture in the range of 50-90% w/w of the total weight of the spice pellet.

Such method is disclosed, wherein the spice pellet blend is mixed after cooling and before being shaped into pellets or cubes.

Such method is disclosed, wherein the healthy oil is clarified butter, and wherein the clarified butter is added in a molten form.

Such method is disclosed, the spice is selected from one or more of: garlic powder, onion powder, white pepper powder, coriander powder, cumin powder, ginger powder, turmeric, fennel powder, red chilli flakes, cardamom, nutmeg, chicken extract powder, or combinations thereof.

Such method is disclosed, wherein the spice mixture comprises disodium inosinate and disodium guanylate (I+G), citric acid, or combinations thereof.

Such method is disclosed, wherein fortification agent selected from the group comprising whey protein, iron, vitamin B, ascorbic acid, or a combination thereof and is added to the dry mixture.

Such method is disclosed, wherein the oligosaccharide is selected from the group consisting of: fructooligosaccharide, Galactooligosaccharide (GOS), Xylooligosaccharide (XOS), Mannan Oligosaccharide (MOS), or a combination thereof.

Such method is disclosed, wherein the oligosaccharide is fructooligosaccharide (FOS).

The following examples are provided to explain and illustrate the preferred embodiments of the present disclosure and do not in any way limit the scope of the disclosure as described.

### EXAMPLES

### Spice Blend Preparation:

The following ingredient list was selected for spices for vegetarian and non-vegetarian based formulations:

TABLE 1
Composition of spice blend
Spice Blend

| Ingredients | Weight (g) |
|---|---|
| Garlic powder | 16.5 |
| Onion powder | 16.5 |
| White pepper powder | 6.2 |
| Coriander powder | 8.9 |
| Cumin powder | 7.6 |
| Nutmeg | 6.4 |
| Ginger powder | 4.9 |
| Turmeric | 2.7 |
| Fennel powder | 4.0 |
| Red chilli flakes | 8.1 |
| Salt | 14 |
| I + G | 3 |
| Citric acid | 0.96 |
| Total | 100 |

All the ingredients mentioned in the Table 1 were added in the given amount to form a spice blend.

For non-vegetarian spice mix, the same ingredients as mentioned in the above table are used along with the chicken extract powder. Chicken extract powder was added to suit the taste. All the ingredients are commercially available.

### Preparation of Spice Pellets:

Spice pellets were prepared manually by using hydraulic pellet press machine with 1.5 cm die size and different pressures were applied to optimize the hardness. The hardness and dispersion analysis were carried out and compared with the marketed Maggi magic veg cubes. All the tablets were made under 1 T pressure.

### Experimental Procedures for the Pellets:

Weight of each pellet for all the experiments conducted was 4 grams. Pellets were formed using the hydraulic pellet press machine by applying 1-ton pressure.

### Example 1, 2, 3: Preparation of Spice Pellets with 50% Spice Blend

2 grams of spice blend was taken (50% of the weight of spice pellet) in a plastic bowl. FOS-HPMC-clarified butter was added to the above spice blend in a ratio of 12:2:1, 6:3:1 and 2.5:1.5:1 amounting to 2 grams

The contents were mixed uniformly, and the mixture was kept in refrigerator at a temperature of 5° C. to 10° C. for 10 min for crystallization/maturation. After 10 min, the blend was mixed again for better homogeneity.

The pellets were prepared by using hydraulic pellet press at 1-ton pressure. The pellets were then subjected to Brookfield texture analyzer for hardness and dissolution time analysis.

TABLE 2
Concentration of ingredients to form spice pellets with 50% spice blend with FOS

| | Spice | | | Oil/clarified | | | |
|---|---|---|---|---|---|---|---|
| | content | FOS | HPMC | butter | Dispersibility | | |
| Example | (wt %) | (wt %) | (wt %) | (wt %) | (Sec) | | Hardness |
| 1 | 50 | 40 | 6.7 | 4 CLB | 1 min | 33 sec | >12000 |
| | | | | (Clarified | | | |
| | | | | butter) | | | |
| 2 | 50 | 30 | 15 | 5 CLB | 1 min | 2 sec | >12000 |
| 3 | 50 | 25 | 15 | 10 CLB | 42 | sec | 7653 |

### Example 4: Preparation of Spice Pellets with 75% Spice Blend with Sugar

75% of spice blend i.e. 3 grams of spice blend was taken in a plastic bowl. Sugar-HPMC-clarified butter was added to the above spice blend in a ratio of 11.7:1.9:1 amounting to 1 gram. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected for analysis such as hardness and dissolution.

TABLE 3
Concentration of ingredients to form spice pellets with 75% spice blend with Sugar

| | Spice content | Sugar | HPMC | Oil/clarified | Dispersibility | |
|---|---|---|---|---|---|---|
| Example | (wt %) | (wt %) | (wt %) | butter (wt %) | (Sec) | Hardness |
| 4 | 75 | 20 | 3.3 | 1.7 CLB | 56 sec | 8756 |
| | | | | (Clarified | | |
| | | | | butter) | | |

### Example 5: Preparation of Spice Pellets with 75% Spice Blend with Maltodextrin

75% of spice blend i.e. 3 grams of spice blend was taken in a plastic bowl. Malto dextrin-HPMC-clarified butter was added to the above spice blend in a ratio of 11.7:1.9:1 amounting to 1 gram.

The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 4
Concentration of ingredients to form spice pellets
with 75% spice blend with Maltodextrin

| | Spice | | | Oil/clarified | | |
|---|---|---|---|---|---|---|
| | content | Maltodextrin | HPMC | butter | Dispersibility | |
| Example | (wt %) | (wt %) | (wt %) | (wt %) | (Sec) | Hardness |
| 5 | 75 | 20 | 3.3 | 1.7 CLB | 50 sec | 8273 |
| | | | | (Clarified | | |
| | | | | butter) | | |

### Example 6: Preparation of Spice Pellets with 75% Spice Blend with FOS

75% of spice blend i.e 3 grams of spice blend was taken in a plastic bowl. FOS-HPMC-clarified butter was added to the above spice blend in a ratio of 11.7:1.9:1 amounting to 1 gram. The contents were mixed uniformly, and the mixture was kept in refrigerator at a temperature of 15 to 10° C. for 10 min for crystallization/maturation.

The pellets were prepared by using hydraulic pellet press at 1 ton pressure. The pellets were then subjected to Brookfield texture analyzer for hardness and dissolution time analysis.

TABLE 5
Concentration of ingredients to form spice pellets with 75% spice blend with FOS

| | Spice | | | Oil/clarified | | |
|---|---|---|---|---|---|---|
| | content | FOS | HPMC | butter | Dispersibility | |
| Example | (wt. %) | (wt. %) | (wt. %) | (wt. %) | (Sec) | Hardness |
| 6 | 75 | 20 | 3.3 | 1.7 CLB | 46 sec | 7584 |
| | | | | (Clarified | | |
| | | | | butter) | | |

### Example 7: Preparation of Spice Pellets with 85% Spice Blend with FOS

85% of spice blend i.e. 3.4 grams of spice blend was taken in a plastic bowl. FOS-HPMC-clarified butter was added to the above spice blend in a ratio of 12:2:1 amounting to 0.6 gram. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 6
Concentration of ingredients to form spice pellets with 85% spice blend with FOS

| | Spice | | | Oil/clarified | | |
|---|---|---|---|---|---|---|
| | content | FOS | HPMC | butter | Dispersibility | |
| Example | (wt %) | (wt %) | (wt %) | (wt %) | (Sec) | Hardness |
| 7 | 85 | 12 | 2 | 1 CLB | 48 sec | 4059 |
| | | | | (Clarified | | |
| | | | | butter) | | |

### Example 8: Preparation of Spice Pellets with 85% Spice Blend with Sugar

85% of spice blend i.e. 3.4 grams of spice blend was taken in a plastic bowl. Sugar-HPMC-clarified butter was added to the above spice blend in a ratio of 12:2:1 amounting to 0.6 gram. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 7
Concentration of ingredients to form spice
pellets with 85% spice blend with Sugar

| | Spice | | | Oil/clarified | | |
|---|---|---|---|---|---|---|
| | content | Sugar | HPMC | butter | Dispersibility | |
| Example | (wt %) | (wt %) | (wt %) | (wt %) | (Sec) | Hardness |
| 8 | 85 | 12 | 2 | 1 CLB | 50 sec | 3488 |
| | | | | (Clarified | | |
| | | | | butter) | | |

### Example 9: Preparation of Spice Pellets with 85% Spice Blend with Maltodextrin

85% of spice blend i.e. 3.4 grams of spice blend was taken in a plastic bowl. Maltodextrin-HPMC-clarified butter was added to the above spice blend in a ratio of 12:2:1 amounting to 0.6 gram. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 8
Concentration of ingredients to form spice pellets
with 85% spice blend with Maltodextrin

| | Spice | | | Oil/clarified | | |
|---|---|---|---|---|---|---|
| | content | Maltodextrin | HPMC | butter | Dispersibility | |
| Example | (wt %) | (wt %) | (wt %) | (wt %) | (Sec) | Hardness |
| 9 | 85 | 12 | 2 | 1 CLB | 60 sec | 5960 |
| | | | | (Clarified | | |
| | | | | butter) | | |

### Example 10 and 11: Preparation of Spice Pellets with 85% Spice Blend with FOS and Vegetable Oil

85% of spice blend i.e. 3.4 grams of spice blend was taken in a plastic bowl. FOS-HPMC-Sunflower vegetable oil was added to the above spice blend in a ratio of 26:3:1 and 1:1:1 amounting to 0.6 gram. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1-ton pressure. The pellets were then subjected to Brookfield texture analyzer for hardness and dissolution time analysis.

TABLE 9
Concentration of ingredients to form spice pellets with 85% spice blend with FOS

| | Spice | | | | | |
|---|---|---|---|---|---|---|
| | content | FOS | HPMC | Vegetable oil | Dispersibility | |
| Example | (wt. %) | (wt. %) | (wt. %) | (wt. %) | (Sec) | Hardness |
| 10 | 85 | 13 | 1.5 | 0.5 vegetable | 46 sec | 6241 |
| | | | | oil | | |
| 11 | 85 | 5 | 5 | 5 vegetable | 30 | 2458 |
| | | | | oil | | |

### Example 12: Preparation of Spice Pellets with 85% Spice Blend with FOS-Whey Protein

85% of spice blend i.e. 3.4 grams of spice blend was taken in a plastic bowl. FOS-HPMC-whey protein-clarified butter was added to the above spice blend in a ratio of 11:2:1:1 amounting to 0.6 gram. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1-ton pressure. The pellets were then subjected to Brookfield texture analyzer for hardness and dissolution time analysis.

TABLE 10
Concentration of ingredients to form spice pellets with 85% spice blend with FOS

| | Spice | | Whey | | Oil/clarified | | |
|---|---|---|---|---|---|---|---|
| | content | FOS | protein | HPMC | butter | Dispersibility | |
| Example | (wt. %) | (wt. %) | (wt. %) | (wt. %) | (wt. %) | (Sec) | Hardness |
| 12 | 85 | 11 | 1 | 2 | 1 CLB | 50 sec | 6400 |
| | | | | | (Clarified | | |
| | | | | | butter) | | |

### Example 13: Preparation of Spice Pellets with 85% Spice Blend with FOS-Iron Premix

85% of spice blend i.e. 3.4 grams of spice blend was taken in a plastic bowl. FOS-HPMC-clarified butter was added to the above spice blend in a ratio of 11:3:1 amounting to 0.6 gram. The contents were mixed uniformly for 2 min. 100 ppm of Iron premix was added to the mixture and continue the blending for 5 more min.

The mixture was kept in refrigerator at a temperature of 15 to 10° C. for 10 min for crystallization/maturation. After 10 min the blend was mixed again for better homogeneity. The pellets were prepared by using hydraulic pellet press at 1 ton pressure. The pellets were then subjected to Brookfield texture analyzer for hardness and dissolution time analysis.

TABLE 11
Concentration of ingredients to form spice pellets
with 85% spice blend with FOS-Iron premix

| | Spice | | Iron | | Oil/clarified | | |
|---|---|---|---|---|---|---|---|
| | content | FOS | premix | HPMC | butter | Dispersibility | |
| Example | (wt. %) | (wt. %) | (wt. %) | (wt. %) | (wt. %) | (Sec) | Hardness |
| 13 | 85 | 11 | 100 | 3 | 1 CLB | 46 sec | 6200 |
| | | | ppm | | (Clarified | | |
| | | | | | butter) | | |

### Example 14: Preparation of Spice Pellets with 85% Spice Blend with FOS-Sugar

85% of spice blend i.e. 3.4 grams of spice blend was taken in a plastic bowl. FOS-HPMC-Sugar-clarified butter was added to the above spice blend in a ratio of 6:2:6:1 amounting to 0.6 gram.

The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 12
Concentration of ingredients to form spice
pellets with 85% spice blend with FOS-Sugar

| | Spice | | | | Oil/clarified | | |
|---|---|---|---|---|---|---|---|
| | content | FOS | Sugar | HPMC | butter | Dispersibility | |
| Example | (wt. %) | (wt. %) | (wt. %) | (wt. %) | (wt. %) | (Sec) | Hardness |
| 14 | 85 | 6 | 6 | 2 | 1 CLB | 38 sec | 8562 |
| | | | | | (Clarified | | |
| | | | | | butter) | | |

### Example 15: Preparation of Spice Pellets with 85% Spice Blend with Maltodextrin-FOS

85% of spice blend i.e. 3.4 grams of spice blend was taken in a plastic bowl. Maltodextrin-HPMC-FOS-clarified butter was added to the above spice blend in a ratio of 6:2:6:1 amounting to 0.6 gram.

The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 13
Concentration of ingredients to form spice pellets with 85% spice blend with FOS

| | Spice | | | | Oil/clarified | | |
|---|---|---|---|---|---|---|---|
| | content | Maltodextrin | FOS | HPMC | butter | Dispersibility | |
| Example | (wt. %) | (wt. %) | (wt. %) | (wt. %) | (wt. %) | (Sec) | Hardness |
| 15 | 85 | 6 | 6 | 2 | 1 CLB | 30 sec | 5951 |
| | | | | | (Clarified | | |
| | | | | | butter) | | |

### Example 16: Preparation of Spice Pellets with 90% Spice Blend with Sugar

90% of spice blend i.e. 3.6 grams of spice blend was taken in a plastic bowl. Sugar-HPMC-clarified butter was added to the above spice blend in a ratio of 16:3:1 amounting to 0.4 grams. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 14
Concentration of ingredients to form spice
pellets with 90% spice blend with Sugar

| | Spice | | | Oil/clarified | | |
|---|---|---|---|---|---|---|
| | content | Sugar | HPMC | butter | Dispersibility | |
| Example | (wt %) | (wt %) | (wt %) | (wt %) | (Sec) | Hardness |
| 16 | 90 | 8 | 1.5 | 0.5 CLB | 47 sec | 4202 |
| | | | | (Clarified | | |
| | | | | butter) | | |

### Example 17: Preparation of Spice Pellets with 90% Spice Blend with Maltodextrin

90% of spice blend i.e. 3.6 grams of spice blend was taken in a plastic bowl. Maltodextrin-HPMC-clarified butter was added to the above spice blend in a ratio of 16:3:1 amounting to 0.4 grams. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 15
Concentration of ingredients to form spice pellets
with 90% spice blend with Maltodextrin

| | Spice | | | Oil/clarified | | |
|---|---|---|---|---|---|---|
| | content | Maltodextrin | HPMC | butter | Dispersibility | |
| Example | (wt. %) | (wt. %) | (wt. %) | (wt. %) | (Sec) | Hardness |
| 17 | 90 | 8 | 1.5 | 0.5 CLB | 41 sec | 4033 |
| | | | | (Clarified | | |
| | | | | butter) | | |

### Example 18: Preparation of Spice Pellets with 90% Spice Blend with FOS

90% of spice blend i.e. 3.6 grams of spice blend was taken in a plastic bowl. FOS-HPMC-clarified butter was added to the above spice blend in a ratio of 16:3:1 amounting to 0.4 grams. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 16
Concentration of ingredients to form spice pellets with 90% spice blend with FOS

| | Spice | | | | | |
|---|---|---|---|---|---|---|
| | content | FOS | HPMC | Oil/clarified | Dispersibility | |
| Example | (wt. %) | (wt. %) | (wt. %) | butter (wt. %) | (Sec) | Hardness |
| 18 | 90 | 8 | 1.5 | 0.5 CLB | 36 sec | 6583 |
| | | | | (Clarified | | |
| | | | | butter) | | |

### Example 19, 20: Preparation of Spice Pellets with 90% Spice Blend with FOS

90% of spice blend i.e. 3.6 grams of spice blend was taken in a plastic bowl. FOS-HPMC-clarified butter was added to the above spice blend in a ratio of 2.5:1.5:1 and 0.75:0.75:1 amounting to 0.4 grams. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 17
Concentration of ingredients to form spice pellets with 90% spice blend with FOS

| | Spice | | | | | |
|---|---|---|---|---|---|---|
| | content | FOS | HPMC | Oil/clarified | Dispersibility | |
| Example | (wt %) | (wt %) | (wt %) | butter (wt %) | (Sec) | Hardness |
| 19 | 90 | 5 | 3 | 2 CLB | 32 sec | 4166 |
| | | | | (Clarified | | |
| | | | | butter) | | |
| 20 | 90 | 3 | 3 | 4 | 28 sec | 2369 |

### Example 21: Preparation of Spice Pellet (Non-Veg) with 85% Spice Blend with FOS

85% of spice blend i.e. 3.4 grams of spice blend was taken in a plastic bowl. FOS-HPMC-clarified butter was added to the above spice blend in a ratio of 12:2:1 amounting to 0.6 grams. The contents were mixed uniformly, and the mixture was kept in refrigerator at a temperature of 15 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 18
Concentration of ingredients to form spice pellet
(non-veg) with 85% spice blend with FOS

| | Spice | | | | | |
|---|---|---|---|---|---|---|
| | content | FOS | HPMC | Oil/clarified | Dispersibility | |
| Example | (wt %) | (wt %) | (wt %) | butter (wt %) | (Sec) | Hardness |
| 21 | 85 | 12 | 2 | 1 CLB | 29 sec | 3700 |
| | | | | (Clarified | | |
| | | | | butter) | | |

### Example 22: Preparation of Spice Pellet (Non-Veg) with 85% Spice Blend with FOS-Whey Protein

85% of spice blend i.e. 3.4 grams of spice blend was taken in a plastic bowl. FOS-HPMC-whey protein-clarified butter was added to the above spice blend in a ratio of 11:2:1:1 amounting to 0.6 grams. The contents were mixed uniformly, and the mixture was kept in refrigerator at a temperature of 5 to 10° C. for 10 min for crystallization/maturation. After 10 min the blend was mixed again for better homogeneity.

The pellets were prepared by using hydraulic pellet press at 1 ton pressure. The pellets were then subjected to Brookfield texture analyzer for hardness and dissolution time analysis.

TABLE 19
Concentration of ingredients to form spice pellet (non-
veg) with 85% spice blend with FOS and whey protein

| | Spice | | Whey | | | | |
|---|---|---|---|---|---|---|---|
| | content | FOS | protein | HPMC | Oil/clarified | Dispersibility | |
| Example | (wt %) | (wt %) | (wt %) | (wt %) | butter (wt %) | (Sec) | Hardness |
| 22 | 85 | 11 | 1 | 2 | 1 CLB | 27 sec | 3200 |
| | | | | | (Clarified | | |
| | | | | | butter) | | |

### Analysis of Spice Pellets:

### Hardness Measurement:

The hardness of the spice pellets was measured using a Brookfield texture analyzer; from Brookfield Engineering Labs with model CT3, using the following procedure:

The texture analyzer was equipped with a cylindrical probe having a diameter 0.5 inch. Spice pellet was positioned vertically under the probe, with the center of pellet in the horizontal plane coinciding with the center of the probe.

The pellet was compressed by lowering the probe at a constant speed of 1 mm/min over a distance of 15 mm till the base of the probe touches the pellet. The reading at which the pellets yields was taken, is the force required to break the pellet and is shown in grams in the graph of load vs time.

### Representative Examples for Hardness Measurement Experiments

### Example 11: Hardness Measurement for Spice Pellets with 85% Spice Blend with FOS and Vegetable Oil

DATA REPORT
Sample Description

| Product Name: | 85P FOS 1G | | Note: |
|---|---|---|---|
| Batch Name: | 13 | | |
| Sample: | 1 | | |
| Dimensions: | | | |
| Shape: | Block | | |
| Length: | 10.00 | mm | |
| Width: | 0.00 | mm | |
| Depth: | 0.00 | mm | |

Test Method

| Test Date: | Sep. 13, 2019 | | Test Time: | 13:57:54 | |
|---|---|---|---|---|---|
| Test Type: | Compression | | Recovery Time: | 0 | s |
| Target: | 5.0 | mm | Same Trigger: | False | |
| Hold Time: | 0 | s | Pretest Speed: | 0 | mm/min |
| Trigger Load: | 7 | g | Data Rate: | 10.00 | points/sec |

| | | | | |
|---|---|---|---|---|
| Test Speed: | 1 | mm/min | Probe: | TA11/1000 |
| Return Speed: | 30 | mm/min | Fixture: | NONE |

| | | | | |
|---|---|---|---|---|
| # of Cycles: | 1.0 | Load Cell: | 10000 | g |

| | |
|---|---|
| Target Type: | Distance |

Results

| Hardness Cycle 1: | 2458.00 | g |
|---|---|---|
| Deformation | 1.35 | mm |
| at Hardness: | | |
| Adhesiveness: | 0.00 | mJ |

### Example 10: Hardness Measurement for Spice Pellets with 85% Spice Blend with FOS and Vegetable Oil

DATA REPORT
Sample Description

| Product Name: | 85P FOS 16G | | Note: |
|---|---|---|---|
| Batch Name: | 13 | | |
| Sample: | 1 | | |
| Dimensions: | | | |
| Shape: | Block | | |
| Length: | 10.00 | mm | |
| Width: | 0.00 | mm | |
| Depth: | 0.00 | mm | |

Test Method

| Test Date: | Sep. 13, 2019 | | Test Time: | 14:00:23 | |
|---|---|---|---|---|---|
| Test Type: | Compression | | Recovery Time: | 0 | s |
| Target: | 5.0 | mm | Same Trigger: | False | |
| Hold Time: | 0 | s | Pretest Speed: | 0 | mm/min |
| Trigger Load: | 7 | g | Data Rate: | 10.00 | points/sec |

| | | | | |
|---|---|---|---|---|
| Test Speed: | 1 | mm/min | Probe: | TA11/1000 |
| Return Speed: | 30 | mm/min | Fixture: | NONE |

| | | | | |
|---|---|---|---|---|
| # of Cycles: | 1.0 | Load Cell: | 10000 | g |

| | |
|---|---|
| Target Type: | Distance |

Results

| Hardness Cycle 1: | 6241.00 | g |
|---|---|---|
| Deformation | 1.46 | mm |
| at Hardness: | | |
| Adhesiveness: | 0.00 | mJ |

### Example 18: Hardness Measurement of Spice Pellet (Non-Veg) with 85% Spice Blend with FOS

DATA REPORT
Sample Description

| Product Name: | 90P FOS | | Note: |
|---|---|---|---|
| Batch Name: | 13 | | |
| Sample: | 1 | | |
| Dimensions: | | | |
| Shape: | Block | | |
| Length: | 10.00 | mm | |
| Width: | 0.00 | mm | |
| Depth: | 0.00 | mm | |

Test Method

| Test Date: | Sep. 13, 2019 | | Test Time: | 13:51:12 | |
|---|---|---|---|---|---|
| Test Type: | Compression | | Recovery Time: | 0 | s |
| Target: | 5.0 | mm | Same Trigger: | False | |
| Hold Time: | 0 | s | Pretest Speed: | 0 | mm/min |
| Trigger Load: | 7 | g | Data Rate: | 10.00 | points/sec |

| | | | | |
|---|---|---|---|---|
| Test Speed: | 1 | mm/min | Probe: | TA11/1000 |
| Return Speed: | 30 | mm/min | Fixture: | NONE |

| | | | | |
|---|---|---|---|---|
| # of Cycles: | 1.0 | Load Cell: | 10000 | g |

| | |
|---|---|
| Target Type: | Distance |

Results

| Hardness Cycle 1: | 6583.00 | g |
|---|---|---|
| Deformation | 1.26 | mm |
| at Hardness: | | |
| Adhesiveness: | 0.00 | mJ |

### Example 22: Hardness Measurement of Spice Pellet (Non-Veg) with 85% Spice Blend with FOS and Whey Protein

DATA REPORT
Sample Description

| Product Name: | SPFHG85-3T | | Note: |
|---|---|---|---|
| Batch Name: | 21 | | |
| Sample: | 1 | | |
| Dimensions: | | | |
| Shape: | Block | | |
| Length: | 10.00 | mm | |
| Width: | 0.00 | mm | |
| Depth: | 0.00 | mm | |

Test Method

| Test Date: | Aug. 21, 2019 | | Test Time: | 14:43:23 | |
|---|---|---|---|---|---|
| Test Type: | Compression | | Recovery Time: | 0 | s |
| Target: | 5.0 | mm | Same Trigger: | False | |
| Hold Time: | 0 | s | Pretest Speed: | 0 | mm/min |
| Trigger Load: | 7 | g | Data Rate: | 10.00 | points/sec |

| | | | | |
|---|---|---|---|---|
| Test Speed: | 1 | mm/min | Probe: | TA11/1000 |
| Return Speed: | 30 | mm/min | Fixture: | NONE |

| | | | | |
|---|---|---|---|---|
| # of Cycles: | 1.0 | Load Cell: | 10000 | g |

| | |
|---|---|
| Target Type: | Distance |

Results

| | | |
|---|---|---|
| Hardness Cycle 1: | 3288.00 | g |

### Example 5: Hardness Measurement of Spice Pellets with 75% Spice Blend with Maltodextrin

DATA REPORT
Sample Description

| Product Name: | Spice Cube | | Note: |
|---|---|---|---|
| Batch Name: | 9 | | |
| Sample: | 1 | | |
| Dimensions: | | | |
| Shape: | Block | | |
| Length: | 13.49 | mm | |
| Width: | 0.00 | mm | |
| Depth: | 3.00 | mm | |

Test Method

| Test Date: | Apr. 8, 2019 | | Test Time: | 11:27:48 | |
|---|---|---|---|---|---|
| Test Type: | Compression | | Recovery Time: | 1 | s |
| Target: | 9.0 | mm | Same Trigger: | False | |
| Hold Time: | 0 | s | Pretest Speed: | 2 | mm/min |
| Trigger Load: | 10 | g | Data Rate: | 10.00 | points/sec |

| | | | | |
|---|---|---|---|---|
| Test Speed: | 1 | mm/min | Probe: | TA10 |
| Return Speed: | 60 | mm/min | Fixture: | NONE |

| | | | | |
|---|---|---|---|---|
| # of Cycles: | 1.0 | Load Cell: | 10000 | g |

| | |
|---|---|
| Target Type: | Distance |

Results

| Hardness Cycle 1: | 8273.00 | g |
|---|---|---|
| Deformation | 0.32 | mm |
| at Hardness: | | |
| % Deformation | 2.40 | % |
| at Hardness: | | |
| Recoverable | −0.27 | mm |
| Deformation | | |
| Cycle 1: | | |
| Adhesiveness: | 0.20 | mJ |
| Fracturability: | 8273.00 | g |

| | with 1% of load sensitivity |
|---|---|
| 1st Fracture | 10.50 with 1% of load sensitivity |
| Work Done: | |
| 1st Fracture | 2.40 with 1% of load sensitivity |
| % Deformation: | |

### Dissolution Time:

The dissolution time of the pellets was measured by following procedure: A portion of 300 ml demineralized water in a 1 liter glass beaker was taken and heated to 80±2° C. One pellet was dispersed under continuous stirring. Dissolution time was measured by stopwatch till the pellet disintegrates completely to form uniform blend.

### Density Measurement:

The density of the pellets was measured by formula:

Density (d)=Mass/Volume of cylindrical cube, where Volume of cylindrical cube V=πr2h

Radius (r) was measured by Vernier calipers.

The density of the pellets for pellets ranges from 1.23 to 1.45 g/cm3.

### Water Activity:

The water activity of the pellets was measured by dew point water activity meter with model 4TE. Instrument was calibrated with standard sodium chloride having with USP grade purity at a concentration of 6.00 mol/kg±0.5% with water activity aw=0.760±0.003.

The water activity for pellets (both veg and non-veg) ranges from 0.45-0.58 aw.

### Friability:

Friability was measured using electro lab friabulator. Minimum three pellets were taken and rotated at 100 rpm. Weight loss was measured after the rotation and values were noted.

Friability values for all pellets were below 1%.

### INDUSTRIAL APPLICABILITY

The disclosed composition is easy to make and is inexpensive. The disclosed composition is used in making dishes with vegetables, meat, cottage cheese and soup/broth etc. A predetermined number of pellets are added to the dish as per the serving size. The spice pellet is added to hot water that has vegetables, rice, meat etc.

The disclosed composition provides the ease of addition in predetermined amount to the food preparations. It is suitable for all methods of cooking. The content of spice can range from 50 to 90% and no fillers are added, it will not alter or change the final food parameters such as color, viscosity etc. The disclosed composition has an adequate hardness that helps in retaining the form of individual pellets rapped. It also ensures shelf life of the product by keeping the flavors intact along with ease of transportation. The disclosed composition has a quick dispensability which ensures ease of preparation.

We claim:

1. A spice pellet comprising:
oligosaccharide in the range of 3-40% w/w of the total weight of the spice pellet;
hydroxy propyl methyl cellulose (HPMC) in the range of 1-15% w/w of the total weight of the spice pellet;
healthy oil in the range 5-10% w/w of the total weight of the spice pellet; and
spice mixture in the range of 50-90% w/w of the total weight of the spice pellet.

2. The spice pellet as claimed in claim 1, wherein the oligosaccharide is selected from the group consisting of: fructooligosaccharide, Galactooligosaccharide (GOS), Xylooligosaccharide (XOS), Mannan Oligosaccharide (MOS), or a combination thereof.

3. The spice pellet as claimed in claim 2, wherein the oligosaccharide is fructooligosaccharide (FOS).

4. The spice pellet as claimed in claim 1, wherein the spice mixture comprises of spices selected from a group comprising garlic powder, onion powder, white pepper powder, coriander powder, cumin powder, ginger powder, turmeric, fennel powder, red chilli flakes, cardamom, nutmeg, chicken extract powder, or combinations thereof.

5. The spice pellet as claimed in claim 4, wherein the spice mixture further comprises flavoring agent selected from a group comprising disodium inosinate and disodium guanylate (I+G), citric acid, or combinations thereof.

6. The spice pellet as claimed in claim 1, comprising fortifying agent selected form a group comprising of whey protein, iron, ascorbic acid, vitamin B or a combination thereof.

7. The spice pellet as claimed in claim 6, wherein the fortification agent is in the range of 0.5 to 5 wt. % of the total weight of the spice pellet.

8. The spice pellet as claimed in claim 3, wherein the FOS is in the range of 5-20% w/w of the total weight of the spice pellet.

9. The spice pellet as claimed in claim 1, wherein the spice mixture is in the range of 70-90% w/w of the total weight of the spice pellet.

10. The spice pellet as claimed in claim 1, wherein the amount of HPMC is less than 2 wt. % of the total weight of the spice pellet.

11. The spice pellet as claimed in claim 1, wherein the amount of clarified butter is less than 5 wt. % of the total weight of the spice pellet.

12. The spice pellet as claimed in claim 1, wherein the spice pellet dissolves in hot water in less than 60 seconds at a temperature in the range of 70° C. to 90° C.

13. A method of making the spice pellet, the method comprising
preparing a dry mixture comprising a spice mixture, oligosaccharide, and hydroxyl propyl methyl cellulose (HPMC);
adding to the dry mixture healthy oil to obtain a spice pellet blend;
cooling the spice pellet blend; and
shaping the cooled spice pellet blend into pellet or cube,
wherein oligosaccharide in the range of 3-40% w/w of the total weight of the spice pellet;
hydroxy propyl methyl cellulose (HPMC) in the range of 1-15% w/w of the total weight of the spice pellet;
healthy oil in the range 5-10% w/w of the total weight of the spice pellet; and
spice mixture in the range of 50-90% w/w of the total weight of the spice pellet.

14. The method as claimed in claim 13, wherein the spice pellet blend is mixed after cooling and before being shaped into pellets or cubes.

15. The method as claimed in claim 13, wherein the heathy oil is clarified butter, and wherein the clarified butter is added in a molten form.

16. The method as claimed in claim 13, wherein the spice is selected from one or more of: garlic powder, onion powder, white pepper powder, coriander powder, cumin powder, ginger powder, turmeric, fennel powder, red chilli flakes, cardamom, nutmeg, chicken extract powder, or combinations thereof.

17. The method as claimed in claim 13, wherein the spice mixture comprises disodium inosinate and disodium guanylate (I+G), citric acid, or combinations thereof.

18. The method as claimed in claim 13, wherein fortification agent selected from the group comprising whey protein, iron, vitamin B, ascorbic acid, or a combination thereof and is added to the dry mixture.

19. The method as claimed in claim 13, wherein the oligosaccharide is selected from the group consisting of: fructooligosaccharide, Galactooligosaccharide (GOS), Xylooligosaccharide (XOS), Mannan Oligosaccharide (MOS), or a combination thereof.

20. The method as claimed in claim 13, wherein the oligosaccharide is fructooligosaccharide (FOS).
